(19) United States
(12) Patent Application Publication
(10) Pub. No.: US 2016/0061671 A1
(43) Pub. Date: Mar. 3, 2016

(54) SYSTEM AND METHOD FOR SELECTING PATH ACCORDING TO SELECTION CONDITIONS

(71) Applicant: NATIONAL APPLIED RESEARCH LABORATORIES, Taipei (TW)

(72) Inventors: Ming-Ying HSU, Taipei (TW); Shenq-Tsong CHANG, Taipei (TW); Ting-Ming HUANG, Taipei (TW)

(73) Assignee: NATIONAL APPLIED RESEARCH LABORATORIES, Taipei (TW)

(21) Appl. No.: 14/470,932

(22) Filed: Aug. 27, 2014

(51) Int. Cl. G01L 1/24; G01B 11/16

(52) U.S. Cl. CPC G01L 1/24; G01B 11/16

(57) ABSTRACT

An optical element stress aberration calculation system and method, where a stress distribution is obtained through a stress analysis and a light tracking technologies, and then a stress distribution generated by incident lights with different viewing angles is calculated, so that a stress aberration error is reduced.

### BACKGROUND OF THE RELATED ART

1. Technical Field

A calculation system and method, and particularly to an optical element stress aberration calculation system and method.

2. Related Art

In analyzing an optical element stress aberration, it is currently to calculate an aberration effect generated by a stress brought about from an incident light entering the optical element in a direction parallel to a light axis.

However, in the real use case, when the incident light enters the optical element having different viewing angles, an error of the aberration effect calculated with the current technology will become large with an increased incident angle.

In view of the above, it may be known that there has been the issue where the calculation of the aberration effect of the stress has an increased error appearing with the increased viewing angle in the prior art. Therefore, there is quite a need to set forth an improvement means to solve this problem.

### SUMMARY

In view of the issue where the calculation of the aberration effect of the stress has an increased error appearing with the increased viewing angle in the prior art, the present invention discloses an optical element stress aberration calculation system and method.

According to a first embodiment of the present invention, the optical element stress aberration calculation system comprises a stress analysis module, analyzing a stress distribution in an optical element; a path analysis module, analyzing an output light path obtained from an incident light onto the optical element; a mapping module, mapping the stress distribution in the optical element onto the output light path; and a calculation module, calculating a stress aberration by a light passing through the optical element according to the stress distribution of the output light path.

According to the first embodiment of the present invention, the optical element stress aberration calculation method comprises steps of analyzing a stress distribution in an optical element; analyzing an output light path obtained from an incident light onto the optical element; mapping the stress distribution in the optical element onto the output light path; and calculating a stress aberration by a light passing through the optical element according to the stress distribution of the output light path.

According to a second embodiment of the present invention, the optical element stress aberration calculation system comprises a stress analysis module, analyzing a stress distribution in each of a plurality of optical elements included in an optical element set; a path analysis module, analyzing an output light path obtained from an incident light onto each of the plurality of optical elements included in the optical element set; a mapping module, mapping the stress distribution in each of the plurality of optical elements included in the optical element set onto the output light path; and a calculation module, calculating an accumulation of the stress distribution generated by a light passing through each of the plurality of optical elements included in the optical element set, to calculate a stress aberration generated by the light passing through each of the plurality of optical elements included in the optical element set.

According to the present invention, the optical element stress aberration calculation method comprises steps of analyzing a stress distribution in each of a plurality of optical elements included in an optical element; analyzing an output light path obtained from an incident light onto each of the plurality of optical elements included in the optical element set; mapping the stress distribution in each of the plurality of optical elements included in the optical element set onto the output light path; and calculating an accumulation of the stress distribution generated by a light to calculate the stress aberration generated by the light passing through each of the plurality of optical elements included in the optical element set.

The system and method of the present invention has the difference as compared to the prior art that a stress distribution across a light path is obtained by using a stain analysis and a light tracking technologies, and then a stress distribution generated by incident lights with different viewing angles is calculated, so that a stress aberration error is obtained.

By using the above technical means, the present invention may achieve the technical efficacy of reduced stress aberration error.

### BRIEF DESCRIPTION OF THE DRAWINGS

The present invention will be better understood from the following detailed descriptions of the preferred embodiments according to the present invention, taken in conjunction with the accompanying drawings, in which:

FIG. 1 is a block diagram of an optical element stress aberration calculation system according to a first embodiment of the present invention;

FIG. 2 is a flowchart of an optical element stress aberration calculation method according to the first embodiment of the present invention;

FIG. 3A is a schematic diagram of a stress distribution in the optical element calculated by the optical element aberration calculation according to the first embodiment of the present invention;

FIG. 3B is a schematic diagram of a stress aberration in the optical element calculated by the optical element aberration calculation according to the first embodiment of the present invention;

FIG. 4 is a block diagram of the optical element stress aberration calculation system according to a second embodiment of the present invention;

FIG. 5 is a flowchart of the optical element stress aberration calculation method according to the second embodiment of the present invention;

FIG. 6A is a schematic diagram of a stress distribution in each of a plurality of optical elements included in an optical element set calculated by the optical element aberration calculation according to the second embodiment of the present invention; and

FIG. 6B through 6E are a schematic diagram of a stress aberration calculated by the optical element aberration calculation according to the second embodiment of the present invention, respectively.

### DETAILED DESCRIPTION

The present invention will be apparent from the following detailed description, which proceeds with reference to the accompanying drawings, wherein the same references relate to the same elements.

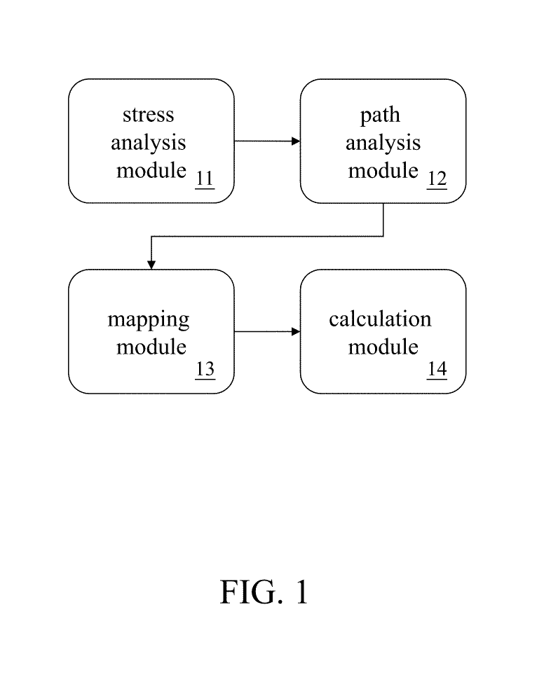

Referring to FIG. 1, which is a block diagram of an optical element stress aberration calculation system according to a first embodiment of the present invention.

According to the first embodiment of the present invention, the optical element stress aberration calculation system comprises a stress analysis module 11, a path analysis module 12, a mapping module 13, and a calculation module 14.

The stress analysis module 11 is used to analyze a stress distribution in an optical element, which may be a convex lens, a concave lens, and the like. However, these are merely examples without limiting the present invention. The optical element may be affected by an environmental temperature to further have different stress at different positions in the optical element. And, the stress analysis module 11 analyzes the stress distribution in the optical element by using a finite element method. That is, the stress analysis module 11 may deduce the stress distribution in the optical element by using the finite element method through the environmental temperature and a boundary condition of the optical element.

The path analysis module 12 is used to analyze an output light path obtained from an incident light onto the optical element, and which is performed by using a ray tracing. This ray tracing is done by calculating how the light propagates in the dielectric, i.e. the light propagates in the dielectric for a distance, a direction and to a new position before the light is absorbed in the dielectric or changed its propagation direction, and generates a new light at the new position, and calculates finally a complete path where the light propagates in the dielectric. In this invention, only an output light path is required to be obtained.

After the stress analysis module 11 analyzes the stress distribution in the optical element and the path analysis module 12 analyzes the output light path from the incident light onto the optical element, the mapping module 13 maps the stress distribution in the optical element onto the output light path.

After the mapping module 13 maps the stress distribution in the optical element onto the output light path, the calculation module 14 may calculate the stress distribution at positions the light goes across to calculate a stress aberration generated by the light going across the optical element. The calculation module 14 calculates the stress aberration generated by the light going across the optical element. That is, the calculation module 14 deduces the stress aberration by using the following equations:

Δn₁=k₁₁σ₁₁+k₁₂(σ₂₂+σ_{zz}),

Δn₂=k₁₁σ₂₂+k₁₂(σ₁₁+σ_{zz}), and

ΔOPD=(Δn₂−Δn₁)L,

wherein n₁ and n₂ are refraction coefficients, k₁₁ and k₁₂ are stress-optical coefficients, σ₁₁ and σ₂₂ are maximum major stress, σ_{zz} is a stress along a propagation direction of the light, and L is a distance along the light propagation direction.

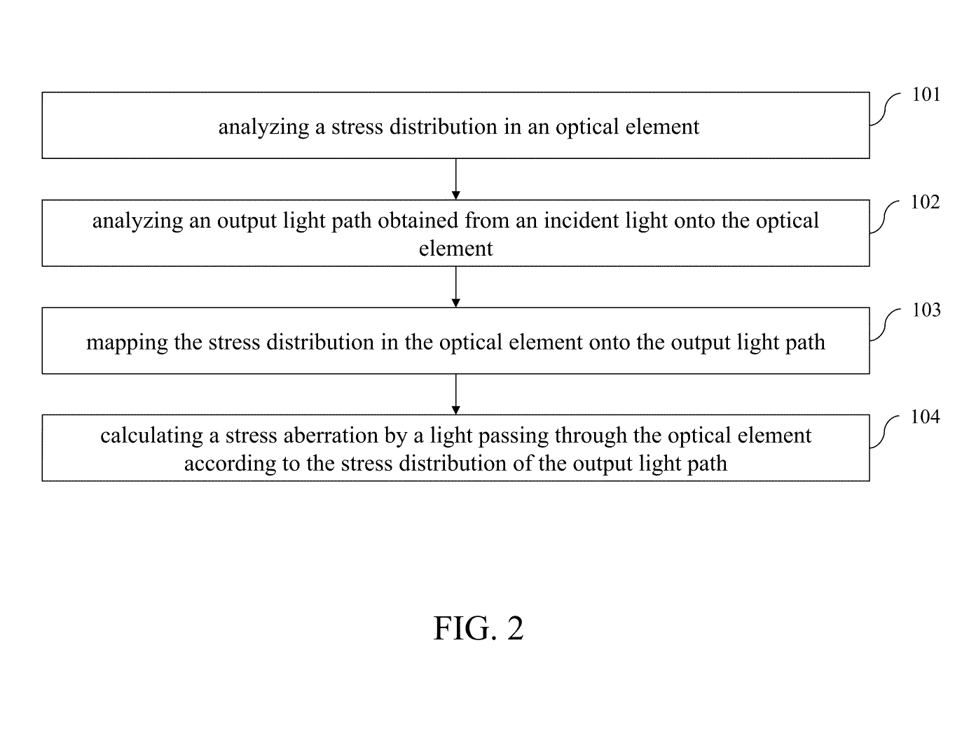

Thereafter, an embodiment is set forth to explain how the first embodiment of the present invention is operated, with reference to FIG. 1 and FIG. 2 simultaneously, in which FIG. 2 is a flowchart of an optical element stress aberration calculation method according to the first embodiment of the present invention.

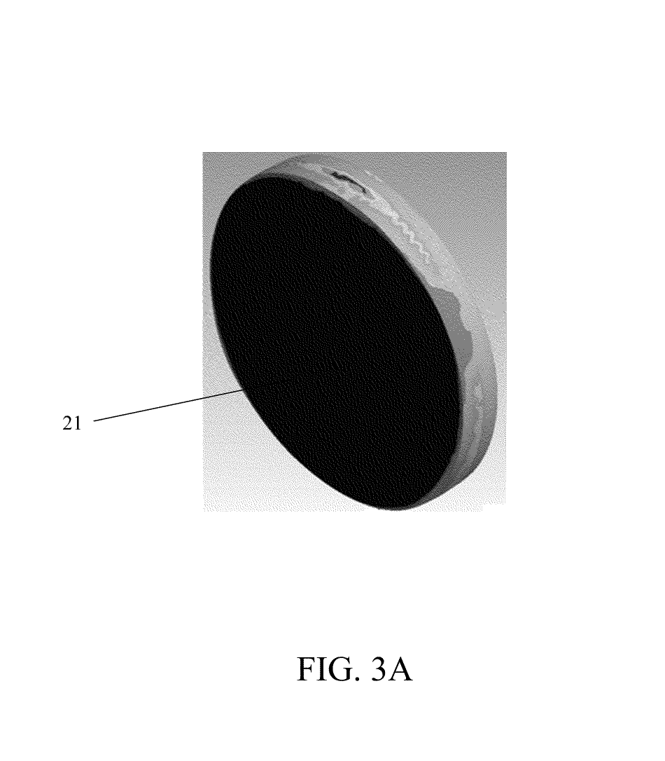

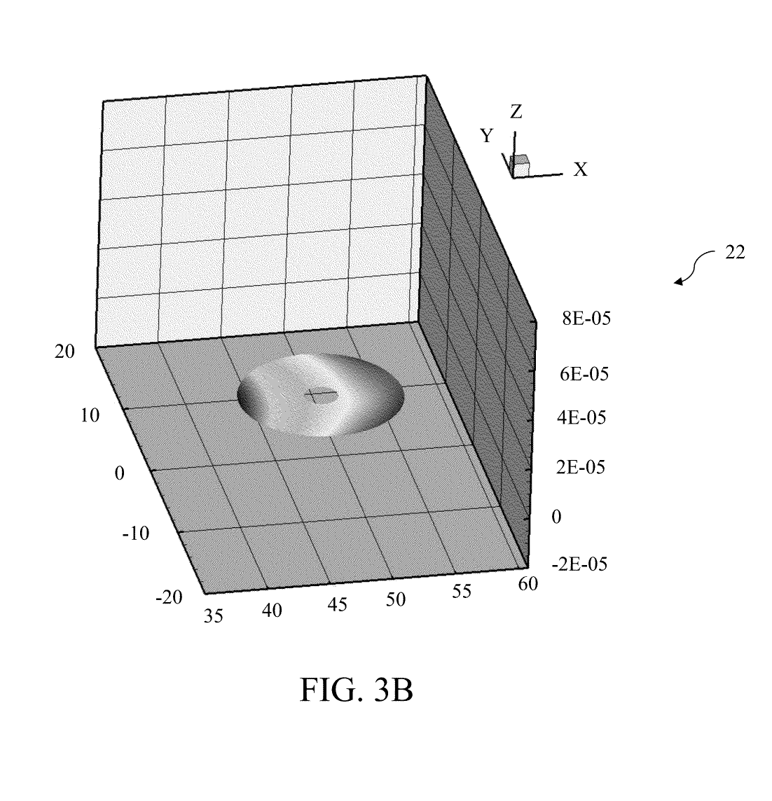

Referring to FIG. 3A, which is a schematic diagram of a stress distribution in the optical element calculated by the optical element aberration calculation according to the first embodiment of the present invention.

The stress analysis module 11 is used to analyze the stress distribution in the optical element 21 (S101). The optical element 21 is exemplified as a convex lens, but which is merely an example without limiting the present invention. The optical element 21 is analyzed by the stress analysis module 11 by using a finite element method, which may be referred to FIG. 3A.

Thereafter, referring simultaneously to FIG. 3A and FIG. 3B, in which FIG. 3B is a schematic diagram of a stress aberration in the optical element calculated by the optical element aberration calculation according to the first embodiment of the present invention;

The path analysis module 12 is used to analyze an output light path from an incident light onto the optical element 21 (S102). This analysis is done by using a ray tracing.

After the stress analysis module 11 analyzes the stress distribution in the optical element 21 and the path analysis module 12 analyzes the output light path from the incident light onto the optical element 21, the stress in the optical element 21 may be mapped onto the output light path by the mapping module 13 (S103).

After the mapping module 13 maps the stress distribution onto the output light path, the calculation module 14 calculates the stress distribution at positions the light having gone through to calculate the stress aberration 22 generated by the light at the positions where the light has gone through (S104). This stress aberration is calculated by using a Zernike method by the calculation module 14. The resulted stress aberration of the optical element associated with the light calculated by the calculation module 14 may be referred to FIG. 3B.

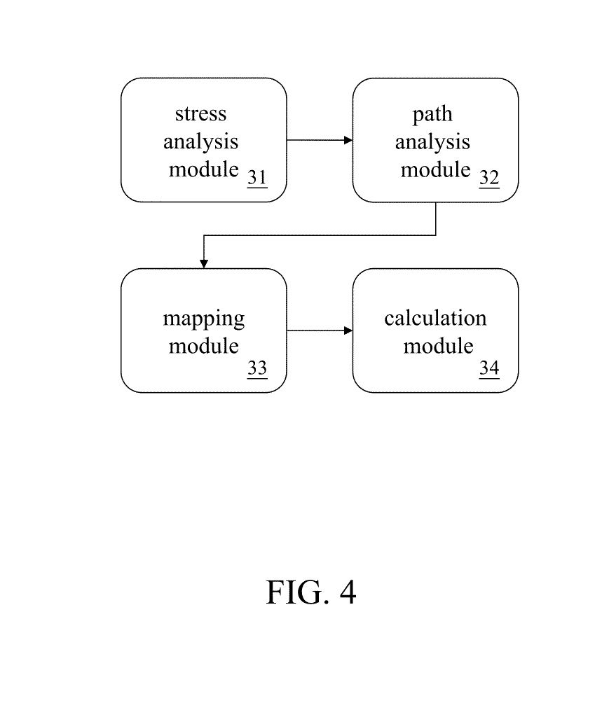

Thereafter, referring to FIG. 4, which is a block diagram of the optical element stress aberration calculation system according to a second embodiment of the present invention.

According to the second embodiment of the present invention, the optical element stress aberration calculation system comprises a stress analysis module 31, a path analysis module 32, a mapping module 33, and a calculation module 34.

The stress analysis module 31 is used to analyze a stress distribution in each of a plurality of optical elements of an optical element set, which may be a convex lens, a concave lens, and the like. However, these are merely examples without limiting the present invention. The optical element may be affected by an environmental temperature to further have different stresses at different positions in the optical element. And, the stress analysis module 31 analyzes the stress distribution in the optical element by using a finite element method for all the optical element set. That is, the stress analysis module 31 may deduce the stress distribution in the optical element by all the optical element set by using the finite element method through the environmental temperature and a boundary condition of the optical element.

The path analysis module 32 is used to analyze an output light path obtained from an incident light onto the optical element for all the optical element set, and which is performed by using a ray tracing. This ray tracing is done by calculating how the light propagates in the dielectric, i.e. the light propagates in the dielectric for a distance, a direction and to a new position before the light is absorbed in the dielectric or changed its propagation direction, and generates a new light at the new position, and calculates finally a complete path where the light propagates in the dielectric. In this invention, only an output light path is required to be obtained.

After the stress analysis module 31 analyzes the stress distribution in the optical element and the path analysis module 12 analyzes the output light path from the incident light onto the optical element, the mapping module 13 maps the stress distribution in the optical element onto the output light path, for all the optical element set.

After the mapping module 33 maps the stress distribution in the optical element onto the output light path, the calculation module 34 may calculate the stress distribution at positions the light goes across to calculate a stress aberration generated by the light going across the optical element for all the optical element set. The calculation module 34 calculates the stress aberration generated by the light going across the optical element for all the optical element set. That is, the calculation module 34 deduces the stress aberration by using the following equations:

Δn₁=k₁₁σ₁₁+k₁₂(σ₂₂+σ_{zz}),

Δn₂=k₁₁σ₂₂+k₁₂(σ₁₁+σ_{zz}), and

ΔOPD=(Δn₂−Δn₁)L,

wherein n₁ and n₂ are refraction coefficients, k₁₁ and k₁₂ are stress-optical coefficients, σ₁₁ and σ₂₂ are maximum major stress, σ_{zz} is a stress along a propagation direction of the light, and L is a distance along the light propagation direction.

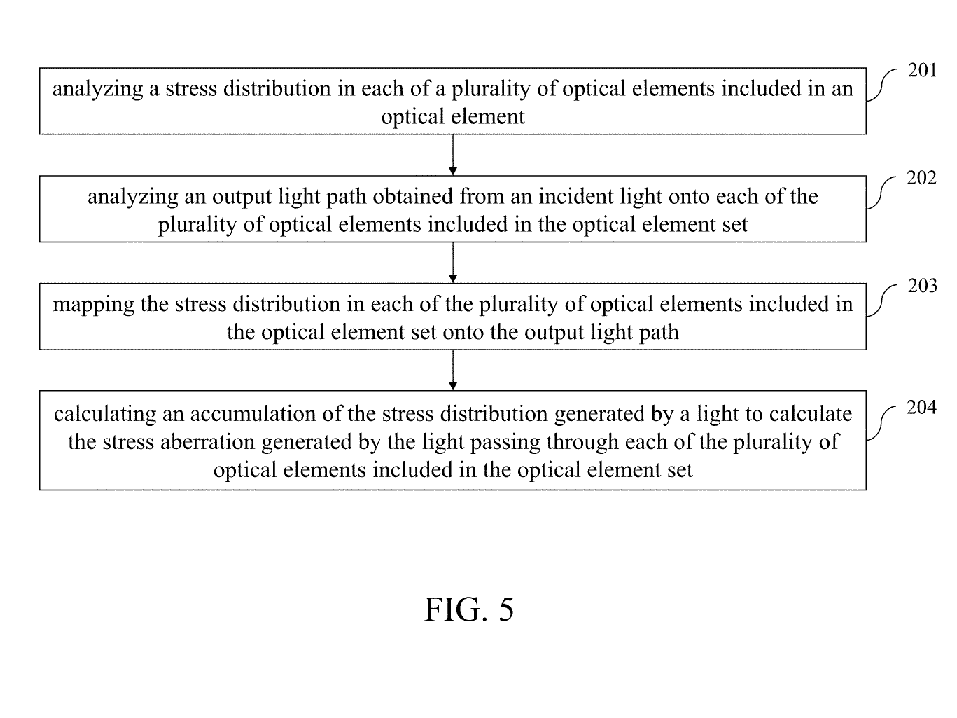

Thereafter, an embodiment is set forth to explain how the second embodiment of the present invention is operated, with reference to FIG. 4 and FIG. 5 simultaneously, in which FIG. 5 is a flowchart of an optical element stress aberration calculation method according to the second embodiment of the present invention.

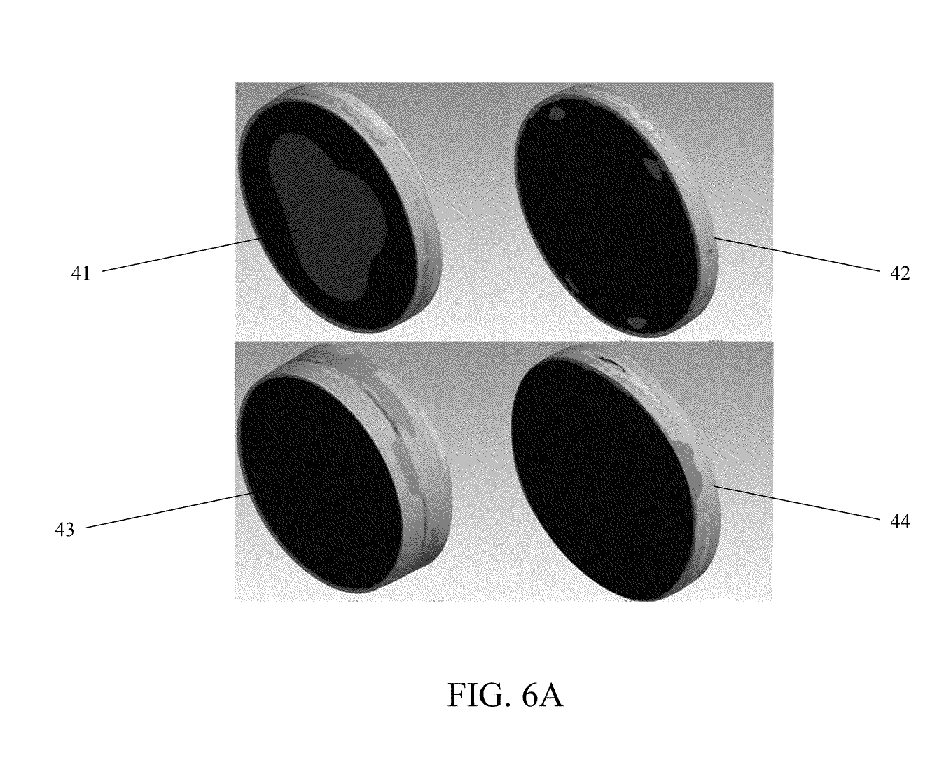

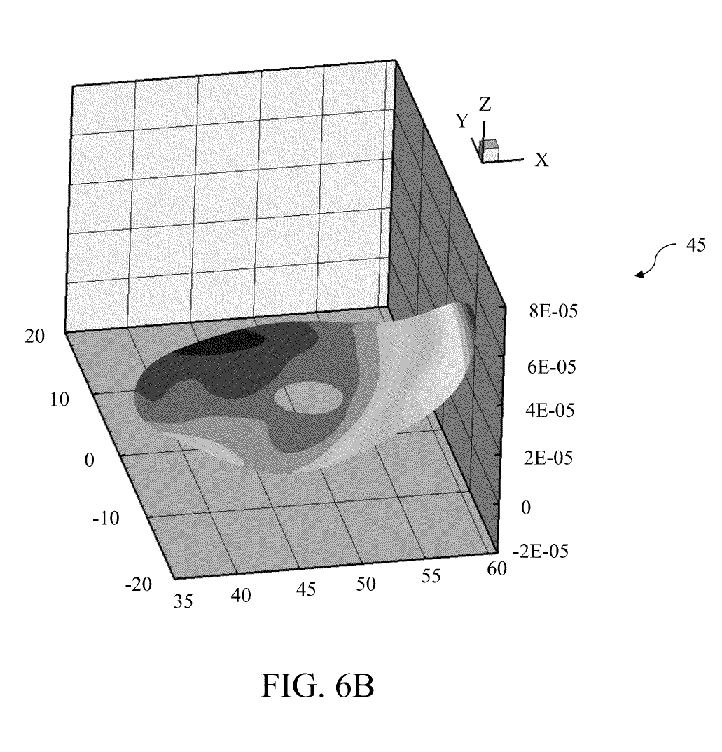

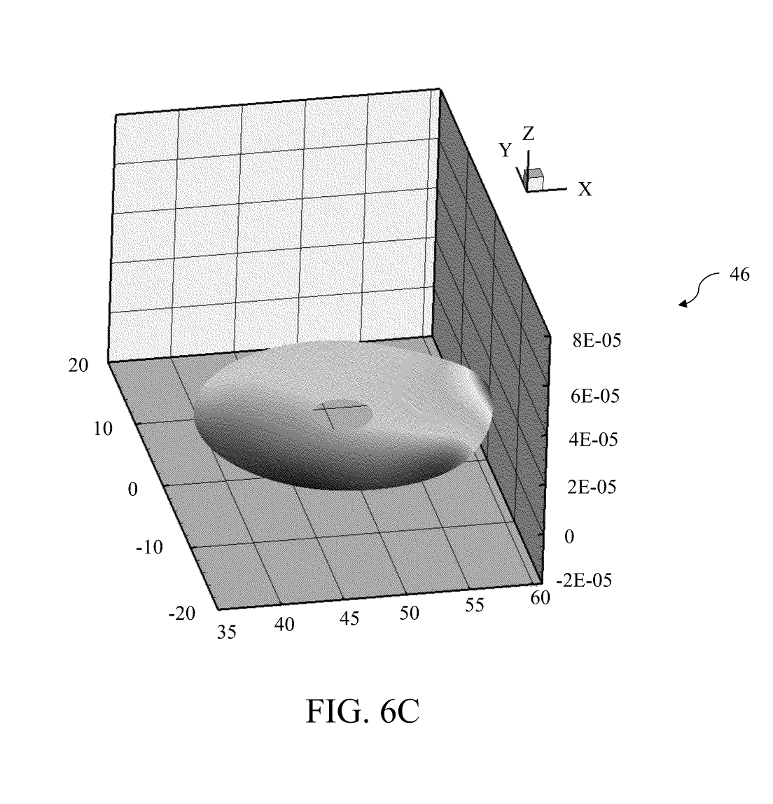

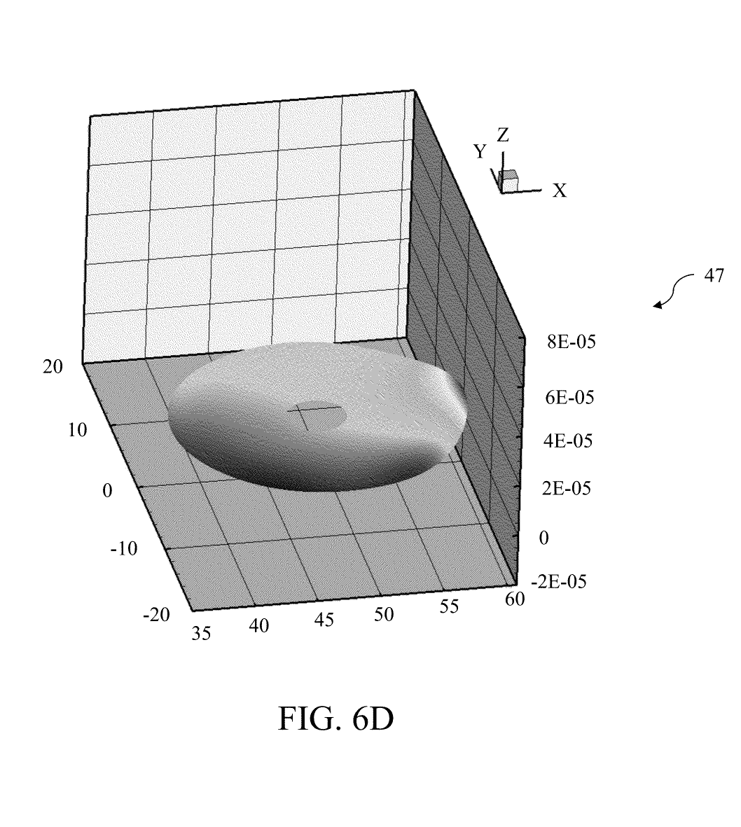

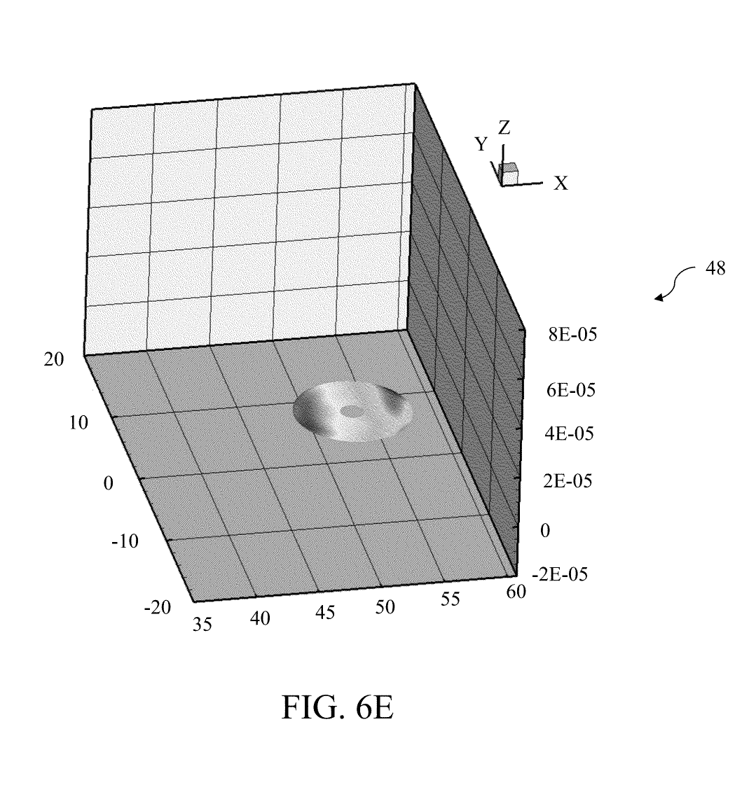

Referring to FIG. 6A, which is a schematic diagram of a stress distribution in the plurality of optical elements of the optical element set calculated by the optical element aberration calculation according to the second embodiment of the present invention.

The stress analysis module 31 is used to analyze the stress distribution in the optical elements 41, 42, 43, 44 (S201). The optical elements 41, 42, 43, 44 are analyzed by the stress analysis module 41 by using a finite element method, which may be referred to FIG. 6A, at portion (a), portion (b), portion (c), and portion (d), respectively.

Thereafter, referring simultaneously to FIG. 6A and FIG. 6B, in which FIG. 6B is a schematic diagram of the stress aberration in each of the plurality of optical elements included in the optical element set calculated by the optical element aberration calculation according to the first embodiment of the present invention;

The path analysis module 32 is used to analyze an output light path from an incident light onto the optical elements 41, 42, 43, 44, respectively (S202). This analysis is done by using a ray tracing.

After the stress analysis module 31 analyzes the stress distribution in the optical elements 41, 42, 43, 44 and the path analysis module 32 analyzes the output light path from the incident light onto the optical elements 41, 42, 43, 44, the stress in the optical elements 41, 42, 43, 44 may be mapped onto the output light path by the mapping module 13, respectively (S203)

After the mapping module 33 maps the stress distribution onto the output light paths, the calculation module 34 calculates the stress distribution at positions the light having gone through to calculate the stress aberration generated by the light at the positions where the light has gone through, for all the optic element set (S204). This stress aberration is calculated for the optic elements 41, 42, 43, 44 by using a Zernike method by the calculation module 134. The resulted stress aberrations 45, 46, 47, 48 of the optical elements 41, 42, 43, 44 associated with the light calculated by the calculation module 34 may be referred to FIG. 6B, FIG. 6C, FIG. 6D, and FIG. 6E.

In view of the above, the system and method of the present invention has the difference as compared to the prior art that a stress distribution across a light path is obtained by using a stain analysis and a light tracking technologies, and then a stress distribution generated by the incident lights with different viewing angles is calculated, respectively, so that a stress aberration error is obtained.

By using the above technical means, the present invention may overcome the issue where the calculation of the aberration effect of the stress has an increased error appearing with the increased viewing angle in the prior art and achieve the technical efficacy of reduced stress aberration error.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical element stress aberration calculation system, comprising:
a stress analysis module, analyzing a stress distribution in an optical element;
a path analysis module, analyzing an output light path obtained from an incident light onto the optical element;
a mapping module, mapping the stress distribution in the optical element onto the output light path; and
a calculation module, calculating a stress aberration by a light passing through the optical element according to the stress distribution of the output light path.

2. The optical element stress aberration calculation system as claimed in claim 1, wherein the stress analysis module analyzes the stress distribution in the optical element by using a finite element method.

3. The optical element stress aberration calculation system as claimed in claim 1, wherein the path analysis module analyzes the output light path obtained from the incident light onto the optical element through a ray tracing.

4. The optical element stress aberration calculation system as claimed in claim 1, wherein the calculation module calculates the stress aberration by a light passing through the optical element according to the stress distribution of the output light path by using a Zernike method.

5. An optical element stress aberration calculation method, comprising steps of:
analyzing a stress distribution in an optical element;
analyzing an output light path obtained from an incident light onto the optical element;
mapping the stress distribution in the optical element onto the output light path; and
calculating a stress aberration by a light passing through the optical element according to the stress distribution of the output light path.

6. The optical element stress aberration calculation method as claimed in claim 5, wherein the step of analyzing the stress distribution in the optical element by using a finite element method.

7. The optical element stress aberration calculation method as claimed in claim 5, wherein the step of analyzing the output light path obtained from the incident light onto the optical element by a ray tracing.

8. The optical element stress aberration calculation method as claimed in claim 5, wherein the step of calculating the stress aberration by a light passing through the optical element according to the stress distribution of the output light path by using a Zernike method.

9. An optical element stress aberration calculation system, comprising:
a stress analysis module, analyzing a stress distribution in each of a plurality of optical elements included in an optical element set;
a path analysis module, analyzing an output light path obtained from an incident light onto each of the plurality of optical elements included in the optical element set;
a mapping module, mapping the stress distribution in each of the plurality of optical elements included in the optical element set onto the output light path; and
a calculation module, calculating an accumulation of the stress distribution generated by a light passing through each of the plurality of optical elements included in the optical element set, to calculate a stress aberration generated by the light passing through each of the plurality of optical elements included in the optical element set.

10. The optical element stress aberration calculation system as claimed in claim 9, wherein the stress analysis module analyzes the stress distribution in each of the plurality of optical elements included in the optical element set by using a finite element method.

11. The optical element stress aberration calculation system as claimed in claim 9, wherein the path analysis module analyzes the output light path obtained from the incident light onto each of the plurality of optical elements included in the optical element set through a ray tracing.

12. The optical element stress aberration calculation system as claimed in claim 9, wherein the calculation module calculates the stress aberration generated by the light passing through each of the plurality of optical elements included in the optical element set by using a Zernike method.

13. An optical element stress aberration calculation method, comprising steps of:
analyzing a stress distribution in each of a plurality of optical elements included in an optical element;
analyzing an output light path obtained from an incident light onto each of the plurality of optical elements included in the optical element set;
mapping the stress distribution in each of the plurality of optical elements included in the optical element set onto the output light path; and
calculating an accumulation of the stress distribution generated by a light to calculate the stress aberration generated by the light passing through each of the plurality of optical elements included in the optical element set.

14. The optical element stress aberration calculation method as claimed in claim 13, wherein the step of analyzing the stress distribution in each of the plurality of optical elements included in the optical element set by using a finite element method.

15. The optical element stress aberration calculation method as claimed in claim 13, wherein the step of analyzing the output light path obtained from the incident light onto each of the plurality of optical elements included in the optical element set by a ray tracing.

16. The optical element stress aberration calculation method as claimed in claim 13, wherein the step of calculating the accumulation of the stress distribution generated by the light to calculate the stress aberration generated by the light passing through each of the plurality of optical elements included in the optical element set by using a Zernike method.
